(19) United States
(12) Patent Application Publication
(10) Pub. No.: US 2026/0087727 A1
(43) Pub. Date: Mar. 26, 2026

(54) CLOUD LANDSCAPE THREE-DIMENSIONAL DATA VISUALIZATION USER INTERFACE

(71) Applicant: SAP SE, Walldorf (DE)

(72) Inventors: Diana Schmidt, Weinheim (DE); Krystian Matias, Heidelberg (DE); Lukasz Milczarek, Czmon (PL)

(21) Appl. No.: 18/985,643

(22) Filed: Dec. 18, 2024

Related U.S. Application Data
(60) Provisional application No. 63/699,328, filed on Sep. 26, 2024.

(51) Int. Cl. G06T 15/08; G06T 19/00

(52) U.S. Cl. CPC G06T 15/08; G06T 19/003; G06T 2200/24

(57) ABSTRACT

A software application detects a request to display a three-dimensional (3D) landscape view of resources deployed for a given entity in at least one cloud platform. Next, the software application retrieves at least one parameter associated with each resource of a plurality of resources deployed for the given entity in the cloud platform. Then, for each parameter, the software application determines a volumetric size based on a value of the parameter. Next, the software application causes volumetric graphical elements with the determined volumetric sizes to be rendered for the plurality of resources deployed for the given entity in the cloud platform. Then, the software application causes the rendered volumetric graphical elements to be displayed, in an interactive user interface on a computing device, as virtual buildings in a virtual city landscape, where the virtual buildings represent the plurality of resources deployed in the cloud platform.

### CROSS-REFERENCE TO RELATED APPLICATIONS

The present application claims priority to U.S. Provisional Application No. 63/699,328, filed Sep. 26, 2024, and entitled “CLOUD LANDSCAPE THREE-DIMENSIONAL DATA VISUALIZATION USER INTERFACE,” and incorporates its disclosure herein by reference in its entirety.

### TECHNICAL FIELD

The present disclosure generally relates to generating a cloud landscape three-dimensional data visualization user interface.

### BACKGROUND

An application can be hosted by a cloud platform such that the application can be remotely accessible to multiple tenants, for example, over the Internet. For example, the application can be available as a cloud-based service including, for example, a software as a service (SaaS) and/or the like. Many organizations rely on such cloud-based enterprise software applications including, for example, enterprise resource planning (ERP) software, customer relationship management (CRM) software, and/or the like. These enterprise software applications may provide a variety of functionalities including, for example, invoicing, procurement, payroll, time and attendance management, recruiting and onboarding, learning and development, performance and compensation, workforce planning, and/or the like. In a complex cloud platform deployment hosting many enterprise software applications, managing the deployment can be a challenging and time-consuming endeavor.

### SUMMARY

In some implementations, a software application of a computing system detects a request to render, in an interactive user interface, a three-dimensional (3D) landscape view of resources deployed for a given entity in at least one cloud platform. Next, the software application retrieves at least one parameter associated with each resource of a plurality of resources deployed for the given entity in the at least one cloud platform. Then, for each parameter, the software application determines a volumetric size based on a value of the parameter. Next, the software application causes volumetric graphical elements with the determined volumetric sizes to be rendered for the plurality of resources deployed for the given entity in the cloud platform. Then, the software application causes the rendered volumetric graphical elements to be displayed, in the interactive user interface on a computing device, as virtual buildings in a virtual city landscape, where the virtual buildings represent the plurality of resources deployed in the cloud platform.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a logical diagram of an example of a system, in accordance with some example implementations of the current subject matter;

FIG. 2 illustrates a logical block diagram of a computing system, in accordance with some example implementations of the current subject matter;

FIG. 3 illustrates an example of a user interface, in accordance with some example implementations of the current subject matter;

FIG. 4 illustrates an example of a user interface, in accordance with some example implementations of the current subject matter;

FIG. 5 illustrates an example of a user interface, in accordance with some example implementations of the current subject matter;

FIG. 6 illustrates an example of a user interface, in accordance with some example implementations of the current subject matter;

FIG. 7 illustrates an example of a user interface, in accordance with some example implementations of the current subject matter;

FIG. 8 illustrates an example of a user interface, in accordance with some example implementations of the current subject matter;

FIG. 9 illustrates an example of a user interface, in accordance with some example implementations of the current subject matter;

FIG. 10 illustrates an example of a user interface for entering a change request, in accordance with some example implementations of the current subject matter;

FIG. 11 illustrates an example of an interactive user interface for viewing a system deployment at a particular point in time, in accordance with some example implementations of the current subject matter;

FIG. 12 illustrates an example of a process for rendering and displaying a user interface of a cloud deployment, in accordance with some example implementations of the current subject matter;

FIG. 13 illustrates an example of a process for rendering and displaying a user interface of a cloud deployment, in accordance with some example implementations of the current subject matter;

FIG. 14 illustrates an example of a process for processing a change request generated within an interactive user interface, in accordance with some example implementations of the current subject matter;

FIG. 15 illustrates an example of a process for adjusting a time representation of an interactive user interface, in accordance with some example implementations of the current subject matter;

FIG. 16A depicts an example of a system, in accordance with some example implementations of the current subject matter; and

FIG. 16B depicts another example of a system, in accordance with some example implementations of the current subject matter.

### DETAILED DESCRIPTION

In an example, a cloud landscape visualization application may generate a user interface (UI) for three-dimensional (3D) data visualization. The cloud landscape visualization application solves the problem of navigating large, complex cloud infrastructure landscapes with large numbers of data points to find landscape-related technical, delivery, and commercial data. Previously, customers were offered a view of landscape elements in a list format. In contrast to the list format view, the 3D landscape visualization UI (i.e., the Skyline UI) makes it easier for the technical user (e.g., System Administrator) to find the technical details they are looking for, using the functions of search, filters, labels, and so on. In an example, the 3D landscape visualization UI enables the navigation from the landscape view to a commercial transaction by simply selecting a landscape element. When selecting the landscape element, an infrastructure change request may be generated. In an example, the infrastructure change request may be to add an additional tier to the landscape, which triggers corresponding pricing information, the creation of a contract amendment, and the e-signature process. Additionally, real-time data related to alerts, downtime notifications, system connections, and other data may be displayed in the 3D landscape visualization UI.

The cloud infrastructure visualization system enables visualizing system landscapes on a 3D plane in the form of a city skyline. The landscape may be automatically updated based on changes in the configuration or delivery datasets. As used herein, the term “landscape” may be defined as a screen display format that is wider than it is high. The navigation around the landscape utilizes game-like inputs such as scroll to zoom in or out, hold shift to pan around the landscape, and so on. The navigation around large landscapes with many objects is made easier with navigation tools like search, filters, labels, and so on. The user can view the landscape at a selected point in time, using a date selector, or view the state of the landscape at different points in time in the past or in the future, according to the deal phasing, making time travel possible with the UI. The visualization shows multiple layers which can be switched between, according to the landscape solutions, tiers and servers, with each layer showing a different level of detail of the landscape.

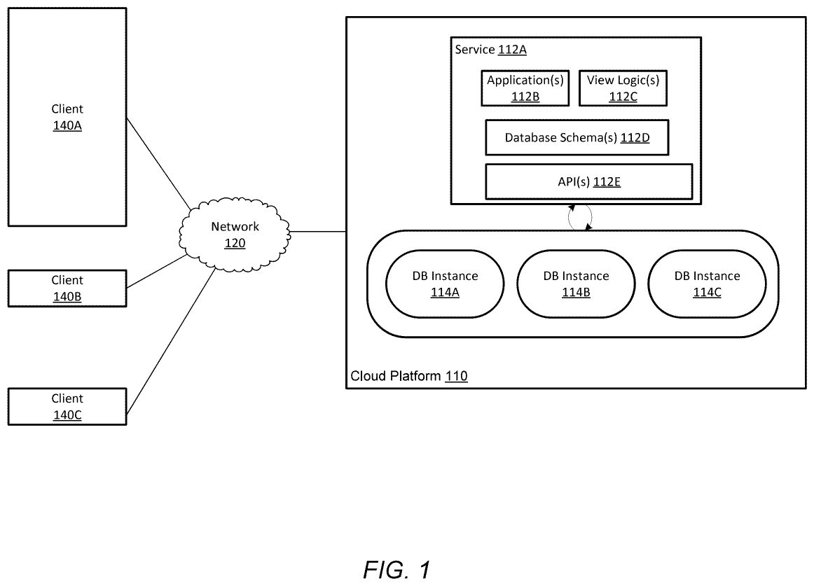

FIG. 1 depicts a diagram illustrating an example of a system 100 consistent with some implementations of the current subject matter. Referring to FIG. 1, the system 100 may include a cloud platform 110. The cloud platform 110 may provide resources that can be shared among a plurality of tenants. For example, the cloud platform 110 may be configured to provide a variety of services including, for example, software-as-a-service (SaaS), platform-as-a-service (PaaS), infrastructure as a service (IaaS), database as a service (DaaS), and/or the like, and these services can be accessed, via network 120, by one or more tenants of the cloud platform 110. Network 120 may be any wired and/or wireless network including, for example, a public land mobile network (PLMN), a wide area network (WAN), a local area network (LAN), a virtual local area network (VLAN), the Internet, and/or the like.

In the example of FIG. 1, the system 100 includes a first tenant 140A (labeled client), a second tenant 140B, and a third tenant 140C, although cloud platform 110 may have other quantities of tenants. The clients may each comprise a user device (e.g., a computer including an application such as a browser or other type of application). The user device may be a processor-based device including, for example, a smartphone, a tablet computer, a wearable apparatus, a virtual assistant, an Internet-of-Things (IOT) appliance, and/or the like. Each client may access, via network 120, at least one of the services at the cloud platform 110. In some implementations, each of the tenants 140A-C represents a separate tenant at the cloud platform 110, such that a tenant's data is not shared with other tenants (absent permission from a tenant). Alternatively, each of the tenants 140A-C may represent a single tenant at the cloud platform 110, such that the tenants do share a portion of the tenant's data.

The cloud platform 110 may include resources, such as at least one computer (e.g., a server), data storage, and a network (including network equipment) that couples the computer(s) and storage. The cloud platform may also include other resources, such as operating systems, hypervisors, and/or other resources, to virtualize physical resources (e.g., via virtual machines), provide deployment (e.g., via containers) of applications (which provide services, for example, on the cloud platform, and other resources). In the case of a “public” cloud platform, the services may be provided on-demand to a client, or tenant, via the Internet. For example, the resources at the public cloud platform may be operated and/or owned by a cloud service provider (e.g., Amazon Web Services, Azure, etc.), such that the physical resources at the cloud service provider can be shared by a plurality of tenants. Alternatively, or additionally, the resources may be hosted on an entity's own private servers (e.g., dedicated corporate servers operated and/or owned by the entity). Alternatively, or additionally, the cloud platform may be considered a “hybrid” cloud platform, which includes a combination of on-premises resources as well as resources hosted by a public or private cloud platform. For example, a hybrid cloud service may include web servers running in a public cloud while application servers and/or databases are hosted on premise (e.g., at an area controlled or operated by the entity, such as a corporate entity).

In the example of FIG. 1, the cloud platform 110 includes a service 112A, which is provided to the client 140A. This service 112A may be deployed via a container, which provides a package or bundle of software, libraries, configuration data to enable the cloud platform to deploy during runtime the service 112A to, for example, one or more virtual machines that provide the service at the cloud platform. In the example of FIG. 1, the service 112A is deployed during runtime, and provides at least one application such as an application 112B (which is the runtime application providing the service at 112A and served to the client 140A). To illustrate further, client 140A may access the application 112B to view data and/or query data stored in a database instance 114A, for example.

The service 112A may also provide view logic 112C. The view logic (also referred to as a view layer) links the application 112B to the data in the database instance 114A, such that a view of certain data in the database instances is generated for the application 112B. For example, the view logic may include, or access, a database schema 112D for database instance 114A in order to access at least a portion of at least one table at the database instance 114A (e.g., generate a view of a specific set of rows and/or columns of a database table or tables). In other words, the view logic 112C may include instructions (e.g., rules, definitions, code, script, and/or the like) that can define how to handle the access to the database instance and retrieve the desired data from the database instance.

The service 112A may include the database schema 112D. The database schema 112D may be a data structure that defines how data is stored in the database instance 114A. For example, the database schema may define the database objects that are stored in the database instance 114A. The view logic 112C may provide an abstraction layer between the database layer (which include the database instances 114A-114B-114C, also referred to more simply as databases) and the application layer, such as application 112B, which in this example is a multitenant application at the cloud platform 110.

The service 112A may also include an interface 112E to the database layer, such as the database instance 114A and the like. The interface 112E may be implemented as an Open Data Protocol (OData) interface (e.g., HTTP message may be used to create a query to a resource identified via a URI), although the interface 112E may be implemented with other types of protocols including those in accordance with REST (Representational state transfer). In the example of FIG. 1, the database instance 114A may be accessed as a service at a cloud platform, which may be the same or different platform from cloud platform 110. In the case of REST compliant interfaces, the interface 112E may provide a uniform interface that decouples the client and server, is stateless (e.g., a request includes all information needed to process and respond to the request), cacheable at the client side or the server side, and the like.

The database instances 114A-114C may each correspond to a runtime instance of a database management system (also referred to as a database). One or more of the database instances may be implemented as an in-memory database (in which most, if not all, the data, such as transactional data, is stored in main memory). In the example of FIG. 1, the database instances are deployed as a service, such as a DaaS, at the cloud platform 110. Although the database instances are depicted at the same cloud platform 110, one or more of the database instances may be hosted on another or separate platform (e.g., on-premise) and/or another cloud platform.

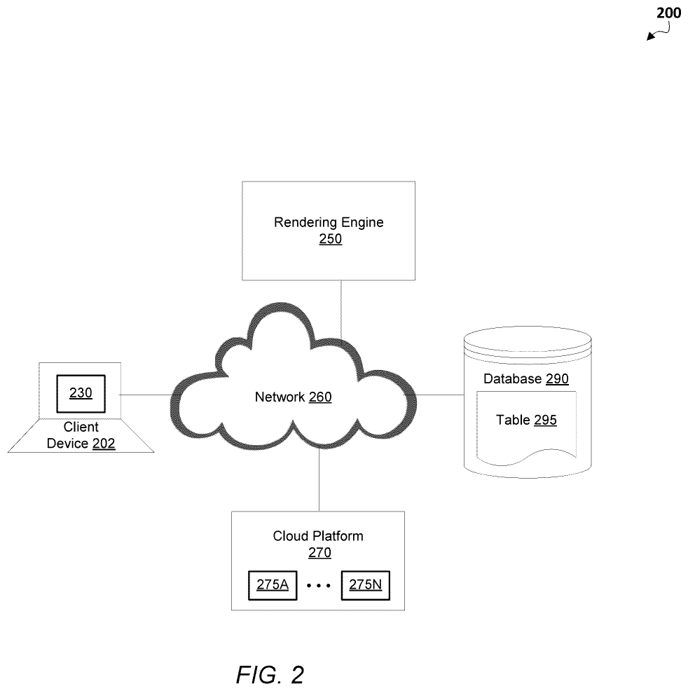

Referring now to FIG. 2, a block diagram of a computing system 200 is shown, in accordance with one or more embodiments of the current subject matter. In an example, computing system includes at least client device 202, rendering engine 250, network 260, cloud platform 270, and database 290. Cloud platform 270 is representative of any number of cloud platforms. Cloud platform 270 may include any number and type of resources 275A-275N, with the resources including one or more of servers, compute units, compute nodes, processors, applications, databases, virtual machines (VMs), memory banks, storage devices, and/or other entities.

Rendering engine 250 may be configured to render and display graphical user interface (GUI) 230 on a display (e.g., screen) of client device 202. Rendering engine 250 may be located and/or be executed by one or more computing devices, with the location and type of computing device varying according to the embodiment. In some cases, the functionality of rendering engine 250 may be split into multiple locations. For example, a portion of the functionality of rendering engine 250 may be located in client device 202 and a portion of the functionality of rendering engine 250 may be located in the cloud platform 270. It is noted that rendering engine 250 may be implemented using any suitable combination of hardware (e.g., processing units, programmable logic, application-specific integrated circuits) and software (e.g., program instructions).

The one or more client devices 202 are representative of any number and type of computing device or computing system, such as a mobile device, phone, tablet, laptop, a wearable apparatus, a personal computer, a workstation, an IoT device, an IoT appliance, and/or the like. The network 260 may be a wired network and/or wireless network including, for example, a public land mobile network (PLMN), a local area network (LAN), a virtual local area network (VLAN), a wide area network (WAN), the Internet, and/or the like.

GUI 230 may be a three-dimensional (3D) landscape view of the cloud infrastructure which is deployed for a given entity. The cloud infrastructure which is deployed may refer to the consumption by the given entity of cloud services and/or cloud resources in a cloud computer environment. Rendering engine 250 may retrieve various parameters associated with the resources of the cloud infrastructure deployed for the given entity from table 295 of database 290. Table 295 is representative of any number and type of tables stored in database 290. Rendering engine 250 may then place and render virtual objects in a 3D environment, where the virtual objects represent the resources of the cloud infrastructure, and where a placement and a size of the virtual objects is based on values of the corresponding parameters retrieved from database 290.

In various embodiments, a virtual representation of a customer landscape is generated and displayed in GUI 230, with the customer landscape including the customer's real-world technical objects that are deployed in one or more cloud platforms. The virtual representation may be displayed in a 3D format in GUI 230. In various embodiments, the virtual representation of the customer landscape is depicted as a city environment, with buildings presented to represent different assets of the customer landscape. The customer may customize the representation, such as by determining what different buildings represent, what the size of the building indicates, and how the buildings are arranged in a particular layout within the city landscape. Depending on the configuration and/or depending on the particular layer of GUI 230, each building may represent a particular data center, each building may represent a particular system (e.g., enterprise resource planning (ERP) system, customer relationship management (CRM) system), each building may represent a particular software application, or each building may represent some other type of asset or resource deployed for the customer.

For example, in one embodiment, the size of a building indicates the capacity or number of resources (e.g., number of servers) of an underlying asset. In another embodiment, the size of a building indicates the cost of an underlying asset. In a further embodiment, the size of a building indicates the number of licenses that have been purchased for the asset (e.g., software application). The locations of where the buildings are placed within the city landscape may be configurable by the user. For example, in one embodiment, the user may select to have the buildings which represent business-critical assets clustered within the center of the city landscape. In other embodiments, the user may arrange the layout of the buildings according to other desirable schemes to make GUI 230 easy to navigate so as to make the management of the infrastructure and interactions more efficient. The visualization of GUI 230 may show a plurality of layers, with each layer showing a different level of detail of the underlying assets.

While embodiments are described herein of a virtual representation depicted as a 3D city landscape, other types of virtual representations may be generated within the scope of this disclosure. For example, in another embodiment, a global view may be generated of a customer landscape. The global view may depict a rotatable globe (i.e., a sphere) which the user may interact with to rotate to different regions of the world. For example, a customer may have assets deployed in data centers dispersed around the world, such as in Asia, Europe, North America, and so on. The global view may allow the customer to rotate the globe to the particular region of interest, and as the user zooms in to a particular region within the global view, the global view may switch to a region view of a particular region, and as the user zooms in to a particular city within the region view, the region view may switch to a city landscape view of a particular city. In one embodiment, the switch between global view, region view, and city view may happen seamlessly as the user zooms in while interacting with the global view. In another embodiment, the user may select a tab or select from a drop-down menu to switch between global view, region view, and city view. More details on the rendering and display of interactive user interfaces will be provided throughout the remainder of this disclosure.

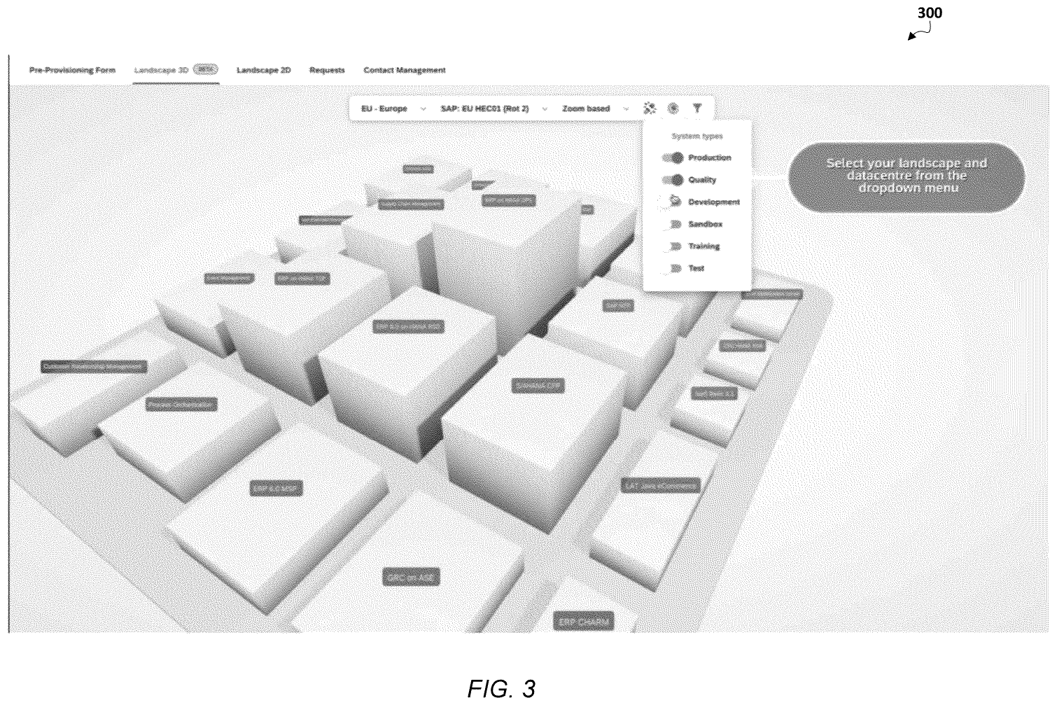

Referring now to FIG. 3, a diagram of a user interface 300 is shown, in accordance with one or more embodiments of the current subject matter. User interface 300 may be rendered to display a visual data representation of the cloud infrastructure (i.e., cloud assets) deployed for a given entity. The given entity may be a customer of a cloud provider, an individual, a group of individuals, a business, an organization (e.g., a non-profit organization), a university, or the like.

The menu bar in the top central portion of user interface 300 allows a user to select the landscape and data center that they wish to view. Once selected, the rendering engine will render a 3D landscape view of the data center, with volumetric graphical elements generated to represent the different assets of the data center. Additionally, as shown in user interface 300, a label may be generated and displayed on top of each volumetric graphical element to specify which asset the volumetric graphical element represents. Different types of assets which may be represented in user interface 300 include, but are not limited to, data centers, servers, compute units, compute nodes, software applications, computing systems, databases, virtual machines, memory banks, and so on. Various combinations of these assets may also represented by the volumetric graphical elements displayed in user interface 300.

As shown in FIG. 3, a pull down menu lists the different system types that can be selected for rendering within user interface 300. In one embodiment, these different system types include production, quality, development, sandbox, training, and test. In other embodiments, other system types may be included in the pull down menu for selection by the user. In various embodiments, user interface 300 may be rotated and viewed at different angles. In other words, the viewing angle at which the different volumetric graphical elements are shown in user interface 300 is merely one particular viewing angle at a particular point in time. The user may navigate and rotate the view that is generated, changing to a more horizontal view, a more vertical view, zooming in, zooming out, and so on.

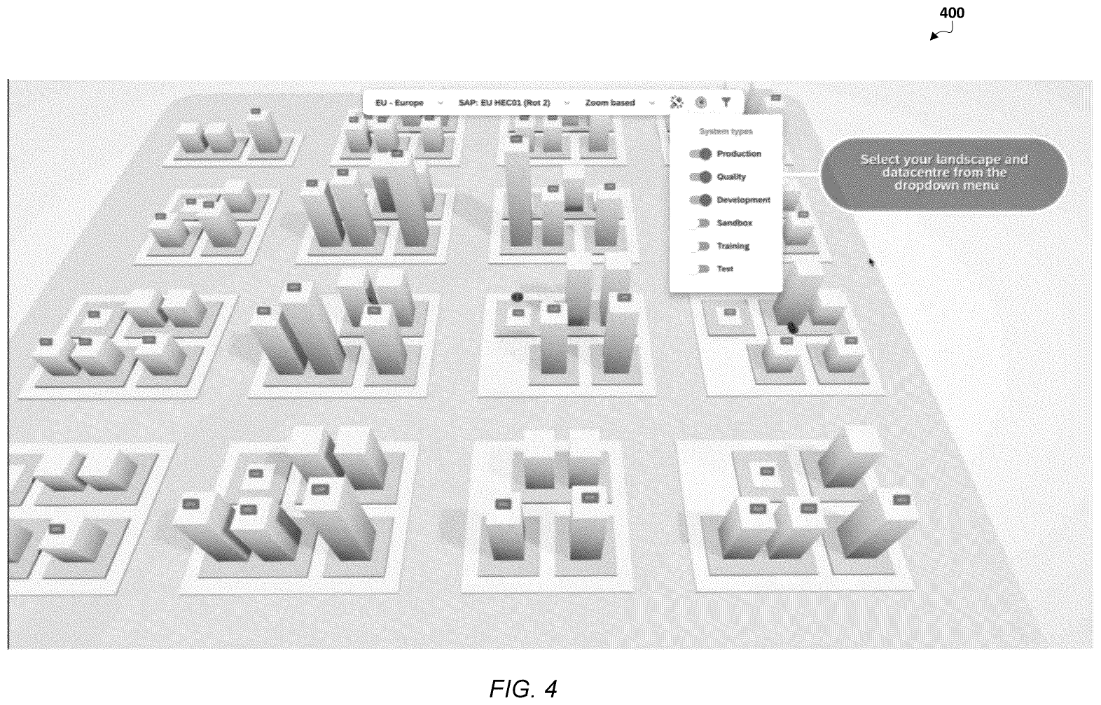

Turning now to FIG. 4, another example of a user interface 400 for displaying a 3D landscape view of a cloud infrastructure deployment is shown, in accordance with one or more embodiments of the current subject matter. As compared to user interface 300 (of FIG. 3), the viewing angle of user interface 400 is more directly overhead. Accordingly, user interface 400 is intended to appear similar to a 3D city skyscraper view. Additionally, user interface 400 is organized into separated, square-like areas within the landscape view that resemble city blocks in an urban landscape separated by streets. In an example, each city block represents a separate data center. In another example, each city block represents a particular application or system (e.g., ERP system, CRM system). In other embodiments, each city block may represent some other desired grouping of assets.

User interface 400 is an interactive user interface such that a user may fluidly navigate through the virtual city by zooming in or out, changing the viewing angle from overhead to more of a side view at a height level with the buildings, and by moving down through the streets as if the user were driving, walking, riding a bike, riding a skateboard, or navigating in some other manner through the city. Alternatively, the user may navigate above the city as if the user were flying in a helicopter, drone, or other aerial vehicle. The interactive user interface 400 enables the user to navigate in any desired manner through the city landscape. In one embodiment, the user may switch modes to change the manner of navigation through the virtual city. In one embodiment, the user may switch modes by selecting a particular mode from a drop-down menu. In other embodiments, switching between modes may be implemented in other ways, such as based on a distance of the user above the city or a height of the user above the ground level. The user may change the distance above the city or height above ground level by zooming in or out while navigating around the landscape.

As can be seen in user interface 400, some of the buildings have circular dots above them. In an example, these circular dots may bounce up and down in real-time as the user is interacting with user interface 400. These bouncing circular dots indicate that alerts have been generated for the corresponding assets. In an example, a bouncing circular dot above a given building means that the server corresponding to the given building is experiencing downtime. In another example, a bouncing circular dot above a given building may indicate that the customer is running out of storage. In a further example, a bouncing circular dot above a given building may indicate that the customer is at the limit of capacity of some resource (e.g., a number of licenses). In other examples, a bouncing circular dot, or a static (i.e., non-bouncing) circular dot, can represent other types of conditions or statuses of the underlying assets. It should be appreciated that other types of visual indicators (besides a circular dot) may be employed in user interface 400 to represent that an alert or notification has been generated for an underlying asset.

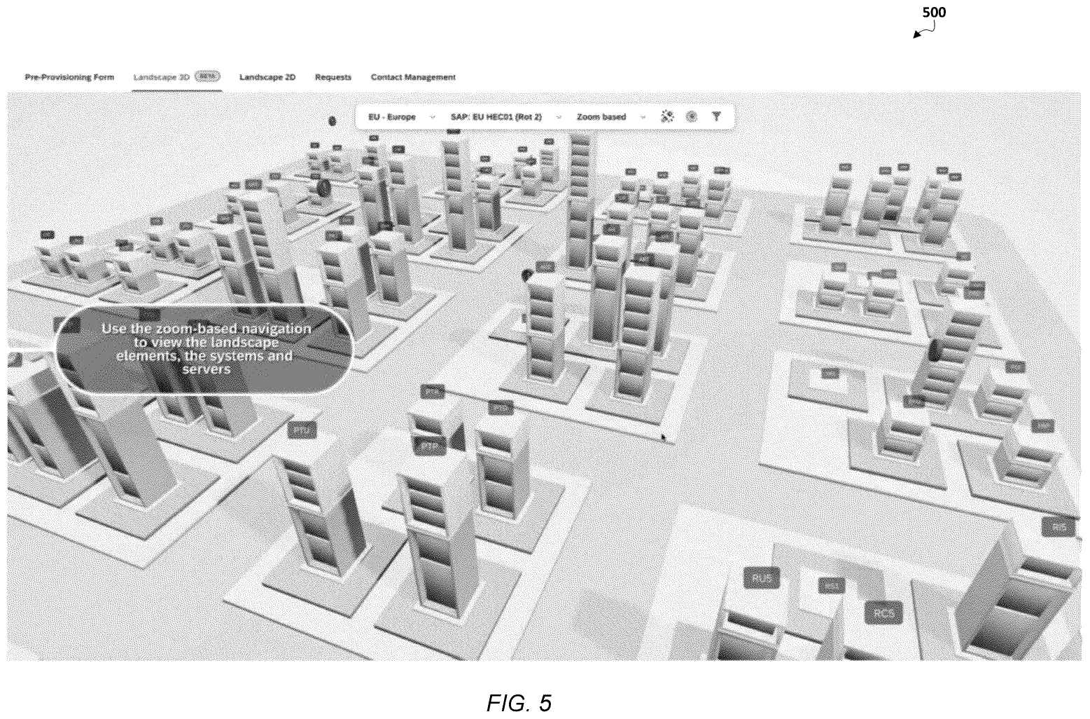

Referring now to FIG. 5, another example of a user interface 500 for displaying a virtual representation of resources deployed in a cloud platform for a given entity is shown, in accordance with one or more embodiments of the current subject matter. As shown in user interface 500, the individual buildings are shown in a segmented fashion, with separate portions stacked on top of each other. These separate portions may represent different quantities of deployed resources at the cloud platform. Some of the buildings (i.e., volumetric cubes) have floating coins (i.e., dots) above them. This indicates that the underlying assets have alerts associated with them. In an example, an alert may indicate that the underlying asset(s) are suffering from downtime. Alternatively, the alerts may indicate that a predefined condition has been detected with respect to the asset and/or the alerts may indicate that some action needs to be taken by the user (e.g., an Administrator).

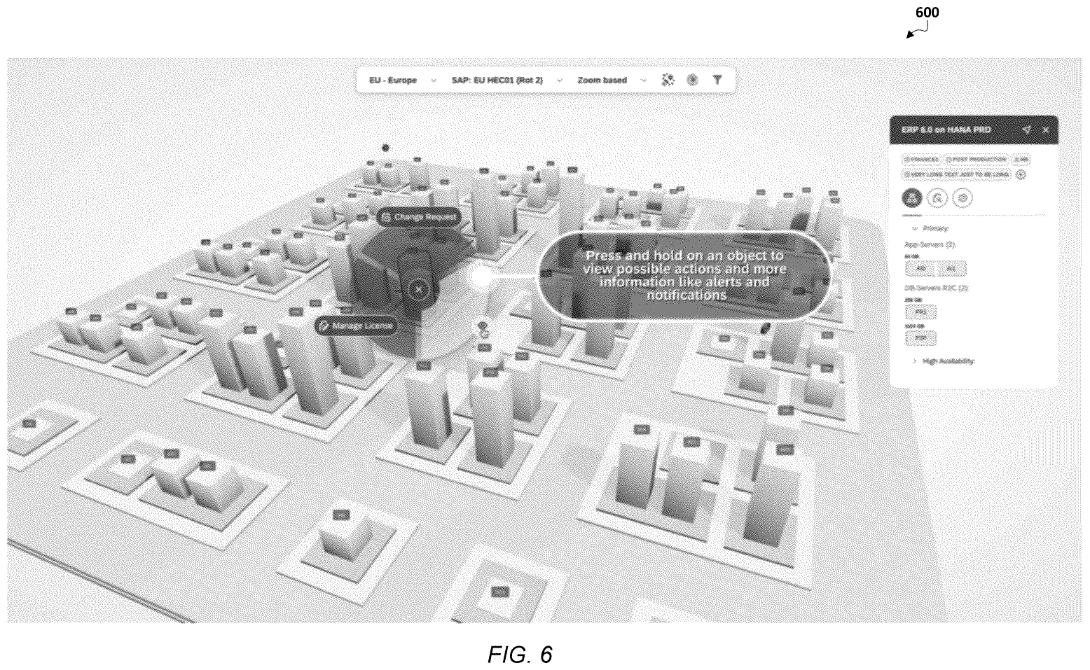

Turning now to FIG. 6, an interactive user interface 600 is shown, in accordance with one or more embodiments of the current subject matter. User interface 600 is another example of an interactive user interface that may be rendered and displayed as part of an application for monitoring the cloud platform resource deployment of a given entity. User interface 600 includes a pop-up graphical element on the right-side that shows additional details associated with the deployment.

At the point in time shown by user interface 600, it is assumed that a user has selected a building in the center of the screen. In response to detecting the user selecting the given building, additional graphical elements are rendered and displayed to allow a user to generate a change request for the underlying resource or to manage the license for the underlying resource. As indicated by the pop-up graphical element in the right-center of the screen, pressing and holding an object allows the user to view and take possible actions and allows the presentation of additional information like alerts and notifications associated with the underlying asset.

Other actions may also be taken with respect to the cloud platform resource deployment based on the user interacting with user interface 600. For example, service requests may be generated by the user interacting with user interface 600. In one embodiment, a user may select a particular building and then generate a service request for the underlying asset, where the service request is a request to restart the underlying asset (e.g., a server, a computing system). In another embodiment, a user may select a specific building in order to make a payment for the asset corresponding to the specific building. In a further embodiment, a user may select a particular building in order to increase or decrease a number of licenses associated with the underlying asset (e.g., a software application). In other embodiments, other actions may be taken with respect to a particular underlying asset by interacting (through user interface 600) with a building which represents the particular underlying asset.

In one embodiment, buildings may be grouped within the city landscape according to the underlying asset's statuses. For example, those assets currently having associated alerts may have their buildings groups together in a first city block. This will allow the user to quickly identify those assets which are experiencing a particular type of alert. In one embodiment, assets may be organized together within the city landscape of user interface 600 based on the particular type of alert they are undergoing.

For example, assets with a first type of alert may have their corresponding buildings grouped together in a first city block, assets with a second type of alert (different from the first type of alert) may have their corresponding buildings grouped together in a second city block, assets with a third type of alert (different from the first and second types of alerts) may have their corresponding buildings grouped together in a third city block, and so on. In another example, assets having received a first type of notification may be grouped in a first city block, assets having received a second type of notification (different from the first type of notification) may be grouped in a second city block, assets having received a third type of notification (different from the first and second types of notifications) may be grouped in a third city block, and so on.

What this means is that in this embodiment, the city landscape that is displayed in the UI may change over time as buildings move around the city based on the status of their respective asset. In other words, a rendering engine (e.g., rendering engine 250 of FIG. 2) may define a given render position of a given graphical element in the city landscape of the UI based on a type of alert or notification associated with a given resource, where the given graphical element represents the given resource. It is noted that this particular implementation may be chosen by a user selecting a particular setting or mode in a drop down menu of user interface 600. The user may also switch to another mode which does not group buildings according to alerts or notifications, but rather keeps the building locations static but uses indicators such as bouncing dots to depict alerts or notifications. In other words, user interface 600 is configurable by the user in the way user interface 600 depicts the user's assets, enabling the user to find the most convenient or efficient configuration for visualizing their cloud infrastructure deployment.

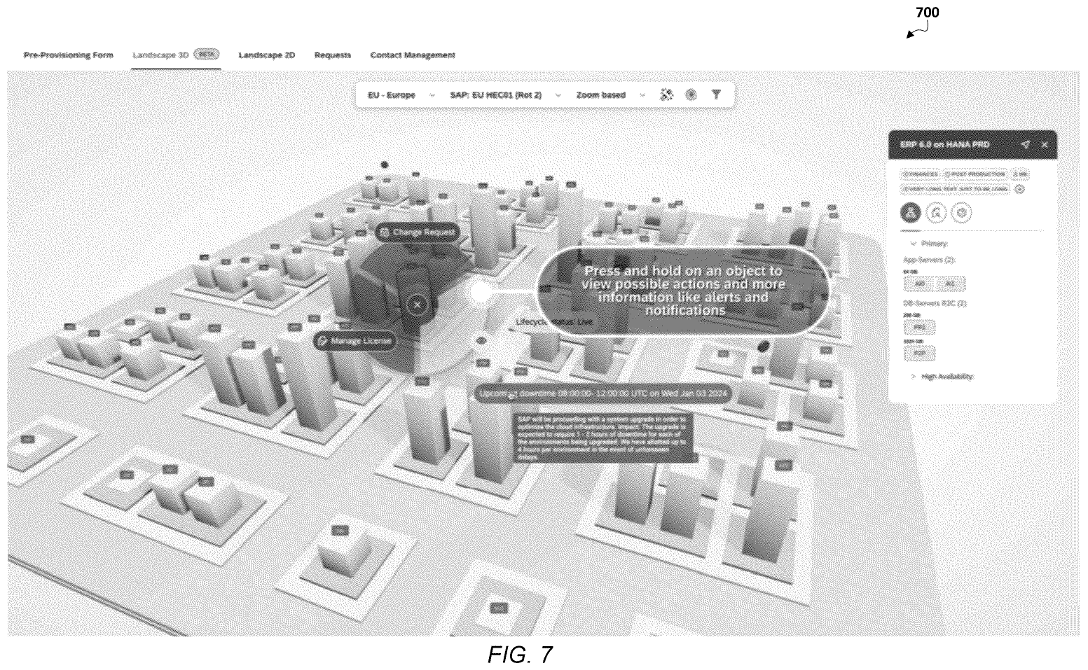

Referring now to FIG. 7, an interactive user interface 700 is shown, in accordance with one or more embodiments of the current subject matter. At the point in time shown in user interface 700, it is assumed that the user has selected a building in order to obtain more information about the object represented by this building. In response to the user selecting the building, more information associated with the underlying asset is generated in pop-up graphical elements. A first graphical element notifies the user that the underlying asset has an upcoming downtime from 08:00 to 12:00 UTC on Wednesday, Jan. 3, 2024. A second graphical element notifies the user that the provider is proceeding with a system upgrade in order to optimize the cloud infrastructure. The second graphical element also specifies the expected impact, such as how much downtime is expected for performing the system upgrade. It is noted that the first and second graphical elements are examples of notifications that may be generated to provide the user with additional information regarding a given resource of the cloud deployment. In other embodiments, other types of graphical elements may be generated to provide other types of information associated with a given resource.

In an example, the user may generate a change request to reschedule the upcoming downtime of a given resource (e.g., a particular server). In this example, the user may select and hold the building that represents the given resource, and then a graphical element may be rendered and displayed in user interface 700 which allows the user to adjust the scheduling of the upcoming downtime. It should be understood that this is merely one example of a type of change request that may be supported by interactive user interface 700. Other types of change requests may also be supported by interactive user interface 700.

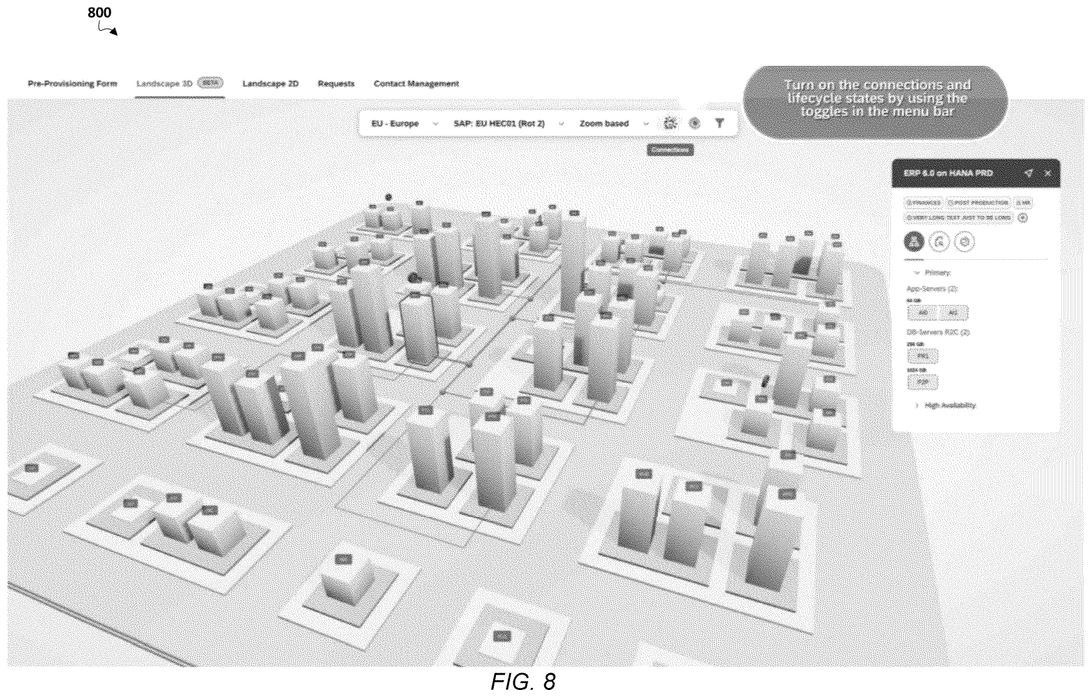

Turning now to FIG. 8, an interactive user interface 800 is shown, in accordance with one or more embodiments of the current subject matter. As shown by the pop-up graphical element on the top right of the interface, the user can cause connection and lifecycle states to be turned on by using the toggles in the menu bar.

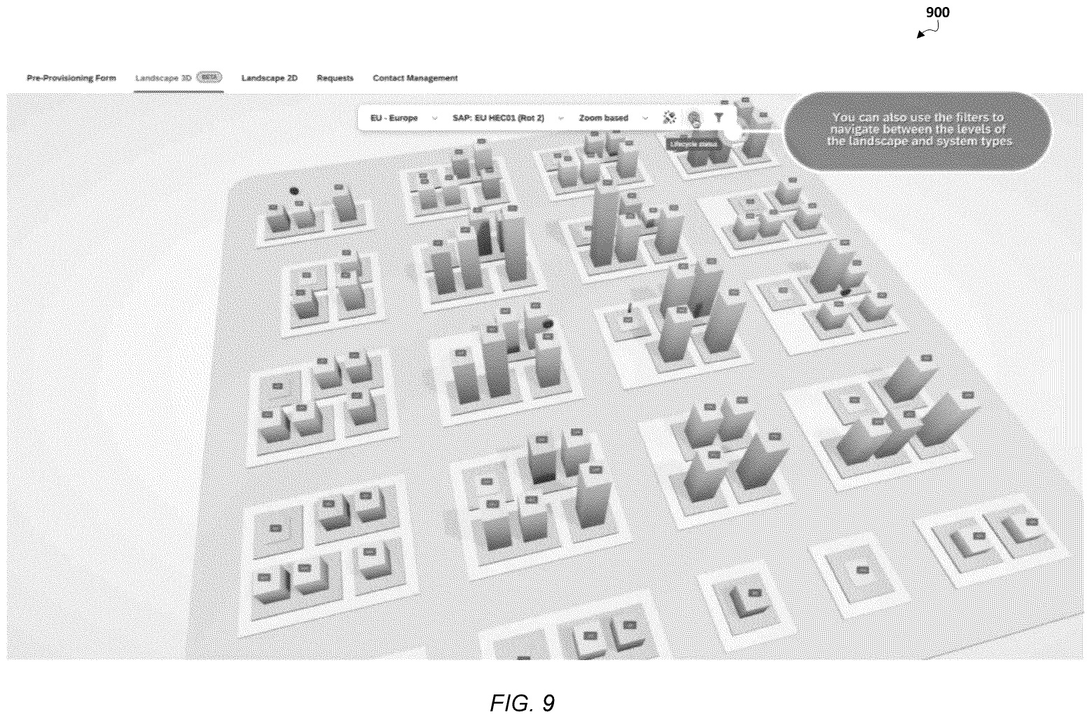

Referring now to FIG. 9, an interactive user interface 900 is shown, in accordance with one or more embodiments of the current subject matter. As shown by the pop-up graphical element in the upper right region of the interface, the user can interact with the interface to use filters to navigate between the levels of the landscape and system types.

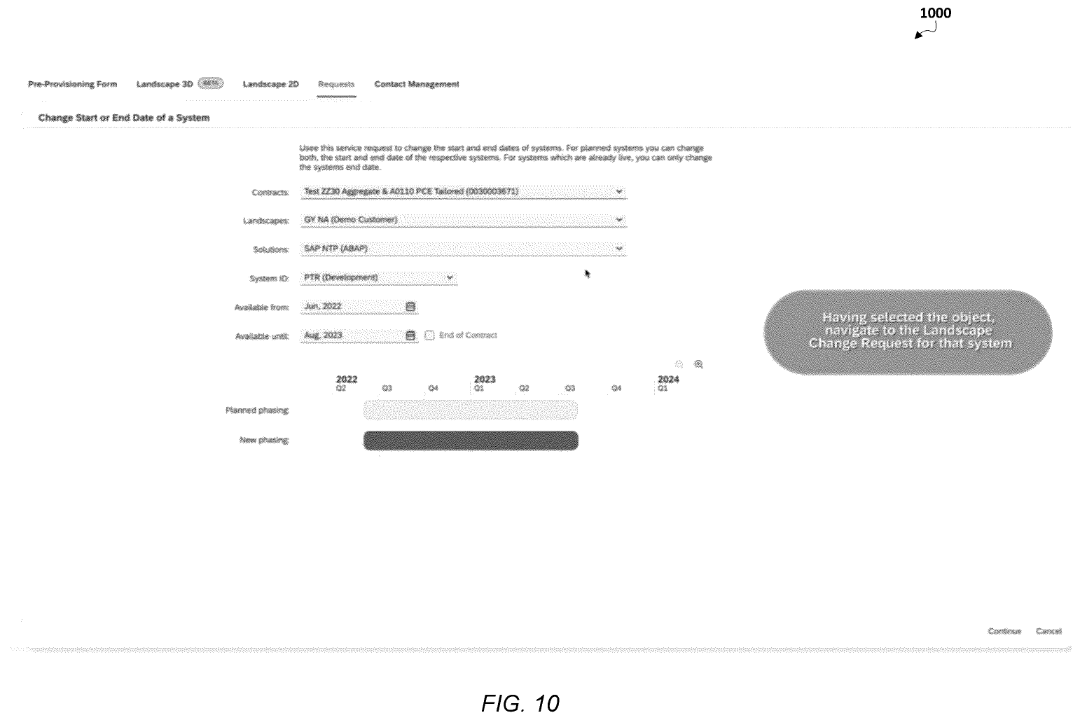

Turning now to FIG. 10, a user interface 1000 for entering a change request is shown, in accordance with one or more embodiments of the current subject matter. In an example, a user may select and hold a particular graphical element in an interactive user interface (e.g., interactive user interface 600 of FIG. 6). When the user selects and holds the graphical element, a change request pop-up graphical element may be rendered and displayed in the interactive user interface. When the user selects and holds the change request pop-up graphical element, the user interface 1000 may be rendered and displayed to allow the user to specify the particular details of the change they would like to make to the underlying system or resource. In the example of user interface 1000, the user may use this screen to change the start and end dates of systems. The user may also utilize user interface 1000 to determine an acceptable time slot for the downtime associated with applying the change request. In other embodiments, other types of user interfaces may be rendered and displayed to allow the user to generate change requests and manage how change requests are applied.

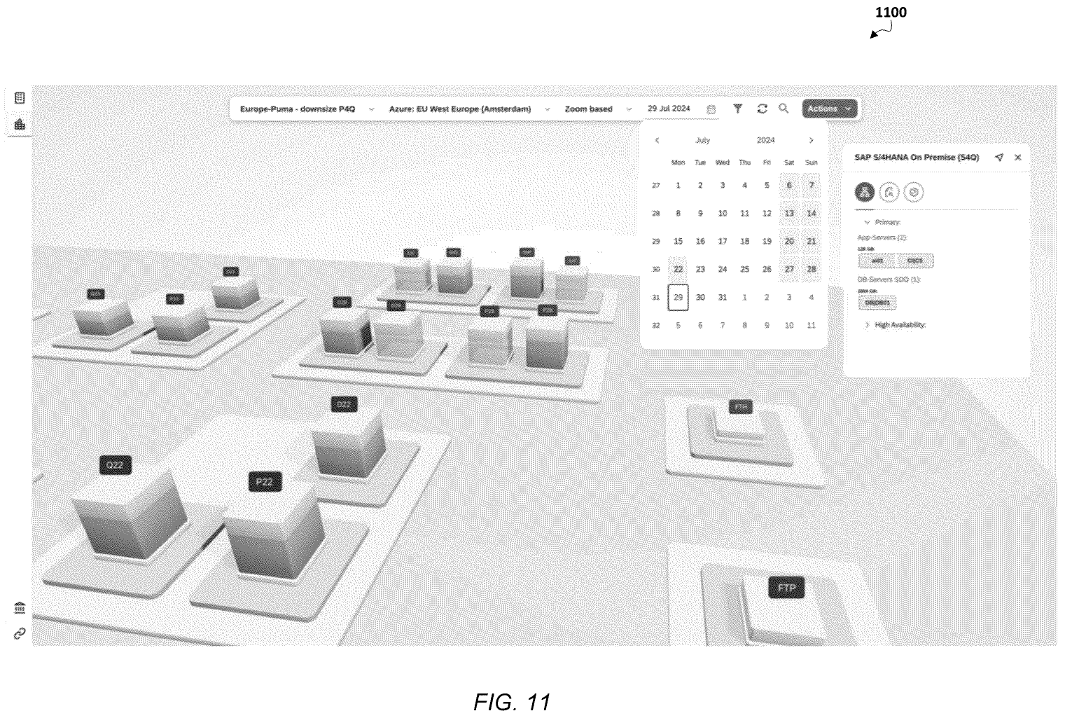

Referring now to FIG. 11, an interactive user interface 1100 for viewing a system deployment at a particular point in time is shown, in accordance with one or more embodiments of the current subject matter. In some cases, a user may wish to view the cloud deployment for a given system as it existed at a point in time in the past. For example, a user may wish to view the cloud deployment for a given system as it existed one month ago, three months ago, one year ago, or at some other historical time. The user may select a specific date from the calendar drop down menu as shown in interactive user interface 1100. Then, after the user has selected the specific date, interactive user interface 1100 will display a city landscape view of the given system as it existed on that specific date.

Additionally, the user may select a date at some point in the future to view how the given system is scheduled to be deployed at that particular date in the future. For example, the user may have contracted to have a particular set of resources deployed for some future date, in anticipation of a new product launch, of a holiday period, of a popular shopping day, or some other future event. Alternatively and/or additionally, the user may wish to repurpose a first set of assets from a first purpose as currently implemented to a second purpose at some future date. The user may submit a change request via a change request user interface (e.g., user interface 1000 of FIG. 10), and then after submitting the change request, the user may utilize user interface 1100 to “time travel” to the future point in time to make sure that the change request is reflected in the future landscape view of the user's assets. This creates a self-service capability for users to submit change requests, cause change requests to be registered, select a window of downtime for applying the change requests, and then verify that the change requests are scheduled to be implemented at a specified future date. For example, the user may have a first system implementing a development environment for a first software application (e.g., ERP), but as the development is nearing completion, the user may wish to repurpose the first system to implement a test environment for a second software application (e.g., CRM) once development has terminated. Variations on the types of scenarios that may be encountered for repurposing assets are possible and are contemplated.

The user may select the future date from the calendar drop down menu to view the city landscape view of the resources which are planned to be allocated for the given system at that future date. As previously described, the user may generate a change request if the user wishes to change the resources which are contracted to be allocated for the given system at the particular future date. In an example, the user may select any of the virtual buildings displayed within the city landscape view to generate a change request.

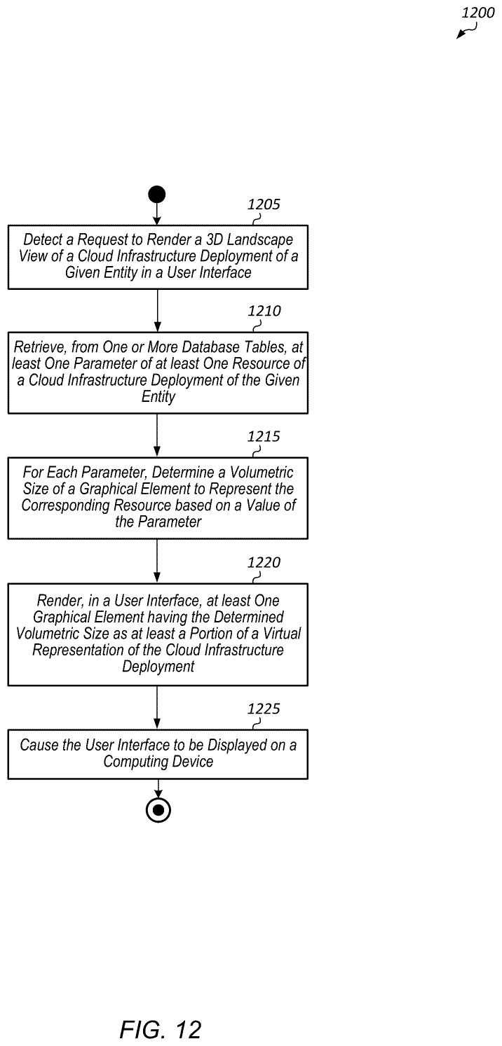

Turning now to FIG. 12, a process for rendering graphical elements of a user interface is depicted, in accordance with one or more embodiments of the current subject matter. A rendering engine (e.g., rendering engine 250 of FIG. 2) detects a request to render a three-dimensional (3D) landscape view of a cloud infrastructure deployment of a given entity in a user interface (block 1205). The given entity (e.g., a company, an organization) may have a plurality of components deployed on a least one cloud platform, with the plurality of components ranging from infrastructure level to application level. Next, the rendering engine retrieves, from one or more database tables, at least one parameter of at least one resource of the cloud infrastructure deployment of the given entity (block 1210). Each parameter may correspond to an amount, quantity, capacity, or size associated with a corresponding resource deployed on the cloud platform for the given entity. In other words, each parameter is related in some way to consumption of a cloud service or cloud asset in a cloud computing environment provided by a cloud service provider.

After block 1210, for each parameter, the rendering engine determines a volumetric size of a graphical element to represent the corresponding resource based on a value of the parameter (block 1215). For example, the parameter may be a number of servers associated with a particular data center, and the volumetric size of the graphical element may be calculated by multiplying the number of servers by a particular volumetric size corresponding to a single server. In this example, a first graphical element representing a first data center having 10 servers would be twice as big as a second graphical element representing a second data center having 5 servers. In other words, a size of each graphical element is proportional to the amount or number of resources corresponding to the respective graphical element. Put another way, the rendering engine determines a first volumetric size of a first graphical element representing a first resource by making the first volumetric size proportional to a first value of a first parameter associated with the first resource.

Next, the rendering engine renders, in the user interface, at least one graphical element having the determined volumetric size as at least a portion of a virtual representation of the cloud infrastructure deployment (block 1220). It is noted that in at least one embodiment, the user interface is an interactive user interface. Then, the rendering engine causes the user interface to be displayed on a computing device (block 1225). After block 1225, method 1200 may end. It is noted that the 3D landscape view may include a plurality of graphical elements representing a plurality of assets. It is also noted that the 3D landscape view may be an interactive view, allowing the user to select individual graphical elements within the view to obtain more information about the corresponding assets, to generate change request, and/or to perform other actions associated with the underlying resources.

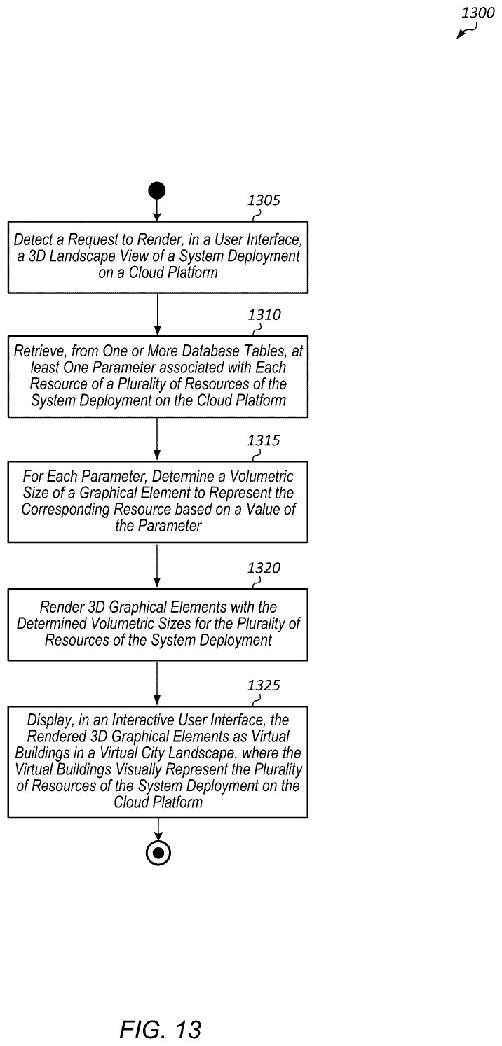

Referring now to FIG. 13, a process for rendering graphical elements of a user interface is depicted, in accordance with one or more embodiments of the current subject matter. A software application (e.g., application 112B of FIG. 1) detects a request to render, in a user interface, a three-dimensional (3D) landscape view of a system deployment on a cloud platform (block 1305). In response to detecting the request, the software application retrieves at least one parameter associated with each resource of a plurality of resources of the system deployment on the cloud platform (block 1310). For each parameter, the software application determines a volumetric size based on a value of the parameter (block 1315). For example, if the resource is a number of servers, then each server may correspond to a given unit of volume. To determine the volumetric size of a given deployment, the software application may multiply the number of servers in the given deployment by the given unit of volume. For example, if each server corresponds to 2 cubic meters of volume, and a deployment has 10 servers, then the volumetric size for the deployment would be 20 cubic meters. The software application may translate the size in cubic meters to a corresponding value that is relevant to the 3D landscape view.

Next, the software application renders 3D graphical elements with the determined volumetric sizes for the plurality of resources of the system deployment (block 1320). Then, the software application displays, in an interactive user interface, the rendered volumetric graphical elements as virtual buildings in a virtual city landscape, where the virtual buildings visually represent the plurality of resources of the system deployment on the cloud platform (block 1325). In other words, the plurality of volumetric graphical elements are organized into an arrangement indicative of a skyline of a city landscape. After block 1325, method 1300 may end.

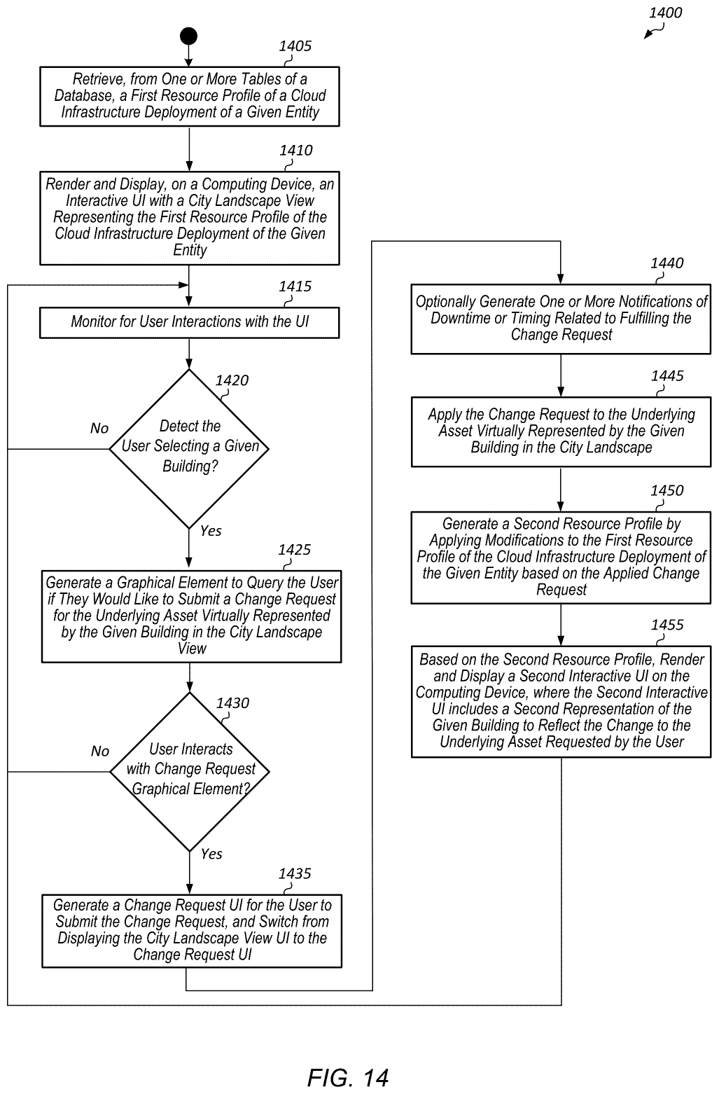

Turning now to FIG. 14, a process for processing a change request generated within an interactive user interface is depicted, in accordance with one or more embodiments of the current subject matter. A software application (e.g., application 112B of FIG. 1) retrieves, from one or more tables of a database, a first resource profile of a cloud infrastructure deployment of a given entity (block 1405). Next, the software application renders and displays, on a computing device, an interactive user interface (UI) with a city landscape view representing the first resource profile of the cloud infrastructure deployment of the given entity (block 1410). While the interactive user interface is being displayed, the software application monitors for user interactions with the UI (block 1415). If the software application detects the user selecting a given building within the city landscape view (conditional block 1420, “yes” leg), then the software application generates a graphical element to query the user if they would like to submit a change request for the underlying asset virtually represented by the given building in the city landscape view (block 1425). If the user interacts with the change request graphical element to indicate that they wish to submit a change request (conditional block 1430, “yes” leg), then the software application generates a change request UI (e.g., UI 1000 of FIG. 10) for the user to submit the change request and switches from displaying the city landscape view UI to the change request UI (block 1435). After the user has submitted the change request for the underlying asset, the software application optionally generates one or more notifications of downtime or timing related to fulfilling the change request (block 1440). Then, the software application applies the change request to the underlying asset virtually represented by the given building in the city landscape view (block 1445). Depending on the embodiment, the change request may be for the allocation of more servers, the upgrading of software (e.g., operating system), supplying additional memory, the allocation of more storage, or otherwise. Next, the software application generates a second resource profile by updating the first resource profile of the cloud infrastructure deployment of the given entity based on the applied change request (block 1450). Next, based on the second resource profile, the software application renders and displays a second interactive UI on the computing device, where the second interactive UI includes a second representation of the given building to reflect the change to the underlying asset requested by the user (block 1455). It is assumed for the purposes of this discussion that the second representation of the given building is different from the first representation of the given building. After block 1455, method 1400 may return to block 1410 with the software application continuing to monitor for user interactions with the UI.

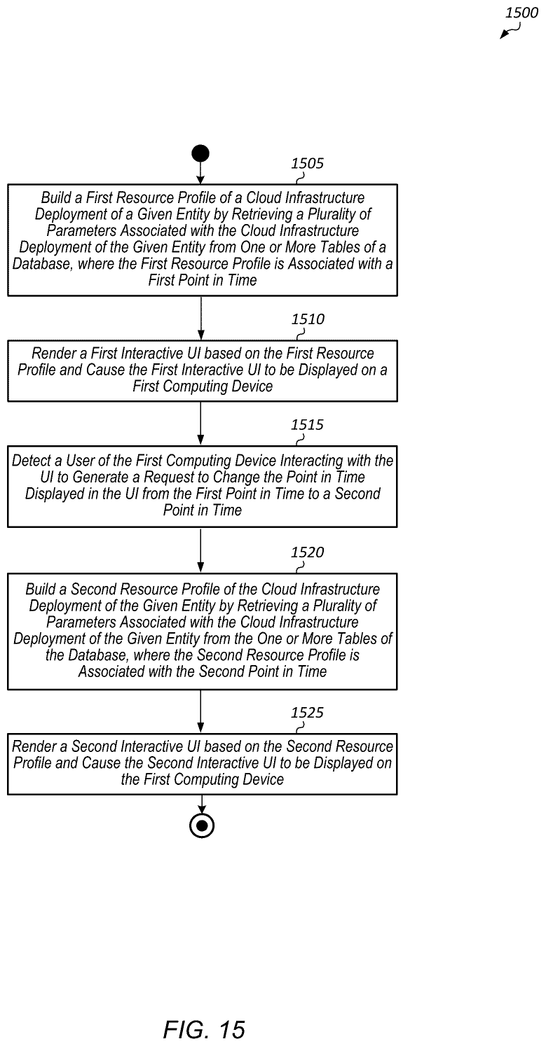

Referring now to FIG. 15, a process for adjusting a time representation of an interactive user interface is depicted, in accordance with one or more embodiments of the current subject matter. A software application (e.g., application 112B of FIG. 1) builds a first resource profile of a cloud infrastructure deployment of a given entity by retrieving a plurality of parameters associated with the cloud infrastructure deployment of the given entity from one or more tables of a database, wherein the first resource profile is associated with a first point in time (block 1505). Next, the software application renders a first interactive user interface (UI) based on the first resource profile and causes the first interactive UI to be displayed on a first computing device (block 1510). It is noted that a set of user configurations may be used to customize how the first interactive UI is rendered and displayed. For example, the user may choose how certain assets are represented, where the buildings (or other types of graphical elements) are located within the city landscape, and so on. In one embodiment, assets of a first type may be represented by buildings of a first color, assets of a second type may be represented by buildings of a second color, assets of a third type may be represented by buildings of a third color, and so on. In another embodiment, assets of a first type may be represented by buildings of a first architectural style, assets of a second type may be represented by buildings of a second architectural style, assets of a third type may be represented by buildings of a third architectural style, and so on. After block 1510, the software application detects a user of the first computing device interacting with the UI to generate a request to change the point in time displayed in the UI from the first point in time to a second point in time (block 1515).

It is assumed for the purposes of this discussion that the second point in time is different from the first point in time. The second point in time may be before (i.e., prior to) the first point in time, or the second point in time may be after (i.e., subsequent to) the first point in time. In other words, if the first point in time refers to the current time (i.e., the present), the second point in time may be in the past, or the second point in time may be in the future.

For example, the user may interact with a calendar graphic element to enter a specific day and time of day for which the user wishes to see the cloud infrastructure deployment of the given entity that existed on that day and time of day (for prior time periods). Alternatively, the user may select a specific day and time of day in the future to view how the cloud infrastructure deployment is scheduled to be deployed for the given entity. In another example, the user may interact with a slider bar graphical element which allows the user to slide the movable element forward or backward in the bar to cause the virtual representation to move forward or backward in time. Other mechanisms for adjusting the time at which the UI displays the virtual representation of how the cloud infrastructure deployment existed or will exist are possible and are contemplated.

After block 1515, the software application builds a second resource profile of the cloud infrastructure deployment of the given entity by retrieving a plurality of parameters associated with the cloud infrastructure deployment of the given entity from one or more tables of a database, wherein the second resource profile is associated with the second point in time (block 1520). Then, the software application renders a second interactive UI based on the second resource profile and causes the second interactive UI to be displayed on the first computing device (block 1525). After block 1525, method 1500 may end.

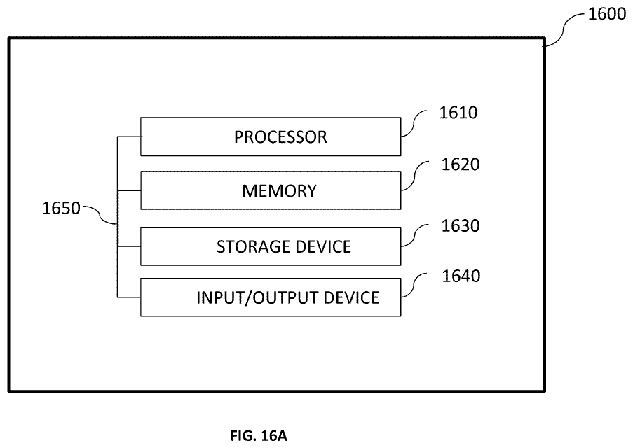

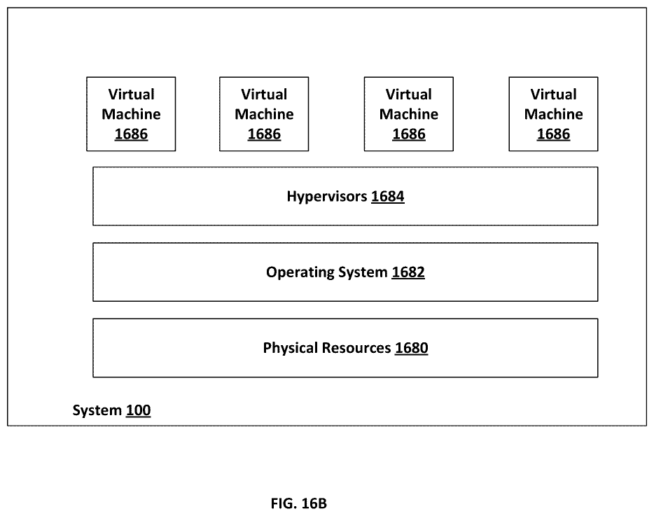

In some implementations, the current subject matter may be configured to be implemented in a system 1600, as shown in FIG. 16A. The system 1600 may include a processor 1610, a memory 1620, a storage device 1630, and an input/output device 1640. Each of the components (e.g., the processor 1610, the memory 1620, the storage device 1630, the I/O device 1640) may be interconnected using a system bus 1650. The processor 1610 may be configured to process instructions for execution within the system 1600. In some implementations, the processor 1610 may be a single-threaded processor. In alternate implementations, the processor 1610 may be a multi-threaded processor. The processor 1610 may be further configured to process instructions stored in the memory 1620 or on the storage device 1630, including receiving or sending information through the input/output device 1640. The memory 1620 may store information within the system 1600. In some implementations, the memory 1620 may be a computer-readable medium. In alternate implementations, the memory 1620 may be a volatile memory unit. In yet some implementations, the memory 1620 may be a non-volatile memory unit. The storage device 1630 may be capable of providing mass storage for the system 1600. In some implementations, the storage device 1630 may be a computer-readable medium. In alternate implementations, the storage device 1630 may be a floppy disk device, a hard disk device, an optical disk device, a tape device, non-volatile solid state memory, or any other type of storage device. The input/output device 1640 may be configured to provide input/output operations for the system 1600. In some implementations, the input/output device 1640 may include a keyboard and/or pointing device. In alternate implementations, the input/output device 1640 may include a display unit for displaying graphical user interfaces.

FIG. 16B depicts an example implementation of the system 100 (of FIG. 1). The system 100 may be implemented using various physical resources 1680, such as at least one or more hardware servers, at least one storage, at least one memory, at least one network interface, and the like. The system 100 may also be implemented using infrastructure, as noted above, which may include at least one operating system 1682 for the physical resources 1680 and at least one hypervisor 1684 (which may create and run at least one virtual machine 1686). For example, each multitenant application may be run on a corresponding virtual machine 1686.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second and the like can, in some situations, relate to an order; as used in a document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include program instructions (i.e., machine instructions) for a programmable processor, and can be implemented in a high-level procedural and/or object-oriented programming language, and/or in assembly/machine language. As used herein, the term “machine-readable storage medium” refers to any computer program product, apparatus and/or device, such as for example magnetic discs, optical disks, memory, and Programmable Logic Devices (PLDs), used to provide machine instructions and/or data to a programmable processor, including a machine-readable storage medium that receives program instructions as a machine-readable signal. The term “machine-readable signal” refers to any signal used to provide machine instructions and/or data to a programmable processor. The machine-readable storage medium can store such program instructions non-transitorily, such as for example as would a non-transient solid state memory or a magnetic hard drive or any equivalent storage medium. The machine-readable storage medium can alternatively or additionally store such machine instructions in a transient manner, such as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A computer-implemented method comprising: detecting a request to render, in a user interface on a computing device, a three-dimensional landscape view of a plurality of resources deployed for a given entity in at least one cloud platform; retrieving, from one or more database tables, at least one parameter associated with each resource of the plurality of resources deployed for the given entity in the at least one cloud platform; for each parameter, determining a volumetric size based on a value of the parameter; rendering volumetric graphical elements with the determined volumetric sizes for the plurality of resources deployed for the given entity in the cloud platform; and causing the rendered volumetric graphical elements to be displayed in the user interface as virtual buildings in a virtual city landscape, wherein the virtual buildings represent the plurality of resources deployed in the at least one cloud platform.

Example 2: The computer-implemented method of Example 1, further comprising enabling a user of the computing device to navigate through the virtual city landscape displayed in the user interface.

Example 3: The computer-implemented method of any of Examples 1-2, further comprising enabling the user of the computing device to change a viewing angle of the virtual city landscape shown within the user interface.

Example 4: The computer-implemented method of any of Examples 1-3, further comprising generating one or more second graphical elements to indicate that there are one or more alerts associated with one or more assets of the cloud infrastructure deployment.

Example 5: The computer-implemented method of any of Examples 1-4, further comprising generating one or more third graphical elements to indicate that there are one or more notifications associated with the one or more assets of the cloud infrastructure deployment.

Example 6: The computer-implemented method of any of Examples 1-5, wherein the at least one parameter indicates a number of deployed assets for a first resource in the cloud infrastructure deployment.

Example 7: The computer-implemented method of any of Examples 1-6, wherein the at least one parameter indicates a capacity deployed for a second resource in the cloud infrastructure deployment.

Example 8: The computer-implemented method of any of Examples 1-7, further comprising: generating a first graphical element as a first building having a first volume, wherein the first graphical element represents a first resource, wherein the first volume is sized based on a first capacity of the first resource; and generating a second graphical element having a second volume, wherein the second graphical element represents a second resource, wherein the second volume is sized based on a second capacity of the second resource, wherein the second volume is twice as much as the first volume, and wherein the second capacity is twice as much as the first capacity; and rendering and displaying the first and second graphical elements in the user interface.

Example 9: The computer-implemented method of any of Examples 1-8, further comprising enabling a user of the computing device to interact with the user interface to customize the virtual city landscape.

Example 10: The computer-implemented method of any of Examples 1-9, further comprising enabling the user to determine what different virtual buildings represent, what the size of the virtual building indicates, and a particular layout of the virtual buildings within the virtual city landscape.

Example 11: The computer-implemented method of any of Examples 1-10, wherein a first volumetric size of a first virtual building indicates a number of servers of an underlying asset.

Example 12: The computer-implemented method of any of Examples 1-11, wherein a first volumetric size of a first virtual building indicates a cost of an underlying asset.

Example 13: The computer-implemented method of any of Examples 1-12, wherein a first volumetric size of a first virtual building indicates a number of licenses that have been purchased for an underlying asset.

Example 14: The computer-implemented method of any of Examples 1-13, wherein each city block in the virtual city landscape represents a separate data center.

Example 15: The computer-implemented method of any of Examples 1-14, further comprising determining a first volumetric size of a first graphical element representing a first resource by making the first volumetric size proportional to a first value of a first parameter associated with the first resource.

Example 16: A system comprising: detecting a request to render, in a user interface on a computing device, a three-dimensional landscape view of a plurality of resources deployed for a given entity in at least one cloud platform; retrieving, from one or more database tables, at least one parameter associated with each resource of the plurality of resources deployed for the given entity in the at least one cloud platform; for each parameter, determining a volumetric size based on a value of the parameter; rendering volumetric graphical elements with the determined volumetric sizes for the plurality of resources deployed for the given entity in the cloud platform; and causing the rendered volumetric graphical elements to be displayed in the user interface as virtual buildings in a virtual city landscape, wherein the virtual buildings represent the plurality of resources deployed in the at least one cloud platform.

Example 17: The system of Example 16, wherein the operations further comprise enabling a user of the computing device to navigate through the virtual city landscape displayed in the user interface.

Example 18: The system of any of Examples 16-17, wherein the operations further comprise generating one or more second graphical elements to indicate that there are one or more alerts associated with one or more assets of the cloud infrastructure deployment.

Example 19: The system of any of Examples 16-18, wherein the operations further comprise determining a first volumetric size of a first graphical element representing a first resource by making the first volumetric size proportional to a first value of a first parameter associated with the first resource.

Example 20: A non-transitory computer readable storage medium storing instructions, which when executed by at least one data processor, result in operations comprising: detecting a request to render, in a user interface on a computing device, a three-dimensional landscape view of a plurality of resources deployed for a given entity in at least one cloud platform; retrieving, from one or more database tables, at least one parameter associated with each resource of the plurality of resources deployed for the given entity in the at least one cloud platform; for each parameter, determining a volumetric size based on a value of the parameter; rendering volumetric graphical elements with the determined volumetric sizes for the plurality of resources deployed for the given entity in the cloud platform; and causing the rendered volumetric graphical elements to be displayed in the user interface as virtual buildings in a virtual city landscape, wherein the virtual buildings represent the plurality of resources deployed in the at least one cloud platform.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method comprising:
detecting a request to render, in a user interface on a computing device, a three-dimensional landscape view of a plurality of resources deployed for a given entity in at least one cloud platform;
retrieving, from one or more database tables, at least one parameter associated with each resource of the plurality of resources deployed for the given entity in the at least one cloud platform;
for each parameter, determining a volumetric size based on a value of the parameter;
rendering volumetric graphical elements with the determined volumetric sizes for the plurality of resources deployed for the given entity in the cloud platform; and
causing the rendered volumetric graphical elements to be displayed in the user interface as virtual buildings in a virtual city landscape, wherein the virtual buildings represent the plurality of resources deployed in the at least one cloud platform.

2. The computer-implemented method of claim 1, further comprising enabling a user of the computing device to navigate through the virtual city landscape displayed in the user interface.

3. The computer-implemented method of claim 2, further comprising enabling the user of the computing device to change a viewing angle of the virtual city landscape shown within the user interface.

4. The computer-implemented method of claim 1, further comprising generating one or more second graphical elements to indicate that there are one or more alerts associated with one or more assets of the cloud infrastructure deployment.

5. The computer-implemented method of claim 4, further comprising generating one or more third graphical elements to indicate that there are one or more notifications associated with the one or more assets of the cloud infrastructure deployment.

6. The computer-implemented method of claim 1, wherein the at least one parameter indicates a number of deployed assets for a first resource in the cloud infrastructure deployment.

7. The computer-implemented method of claim 6, wherein the at least one parameter indicates a capacity deployed for a second resource in the cloud infrastructure deployment.

8. The computer-implemented method of claim 1, further comprising:
generating a first graphical element as a first building having a first volume, wherein the first graphical element represents a first resource, wherein the first volume is sized based on a first capacity of the first resource;
generating a second graphical element having a second volume, wherein the second graphical element represents a second resource, wherein the second volume is sized based on a second capacity of the second resource, wherein the second volume is twice as much as the first volume, and wherein the second capacity is twice as much as the first capacity; and
rendering and displaying the first and second graphical elements in the user interface.

9. The computer-implemented method of claim 1, further comprising enabling a user of the computing device to interact with the user interface to customize the virtual city landscape.

10. The computer-implemented method of claim 9, further comprising enabling the user to determine what different virtual buildings represent, what the size of the virtual building indicates, and a particular layout of the virtual buildings within the virtual city landscape.

11. The computer-implemented method of claim 1, wherein a first volumetric size of a first virtual building indicates a number of servers of an underlying asset.

12. The computer-implemented method of claim 1, wherein a first volumetric size of a first virtual building indicates a cost of an underlying asset.

13. The computer-implemented method of claim 1, wherein a first volumetric size of a first virtual building indicates a number of licenses that have been purchased for an underlying asset.

14. The computer-implemented method of claim 1, wherein each city block in the virtual city landscape represents a separate data center.

15. The computer-implemented method of claim 1, further comprising determining a first volumetric size of a first graphical element representing a first resource by making the first volumetric size proportional to a first value of a first parameter associated with the first resource.

16. A system comprising:
at least one processor; and
at least one memory storing instructions that, when executed by the at least one processor, cause operations comprising:
detecting a request to render, in a user interface on a computing device, a three-dimensional landscape view of a plurality of resources deployed for a given entity in at least one cloud platform;
retrieving, from one or more database tables, at least one parameter associated with each resource of the plurality of resources deployed for the given entity in the at least one cloud platform;
for each parameter, determining a volumetric size based on a value of the parameter;
rendering volumetric graphical elements with the determined volumetric sizes for the plurality of resources deployed for the given entity in the cloud platform; and
causing the rendered volumetric graphical elements to be displayed in the user interface as virtual buildings in a virtual city landscape, wherein the virtual buildings represent the plurality of resources deployed in the at least one cloud platform.

17. The system of claim 16, wherein the operations further comprise enabling a user of the computing device to navigate through the virtual city landscape displayed in the user interface.

18. The system of claim 16, wherein the operations further comprise generating one or more second graphical elements to indicate that there are one or more alerts associated with one or more assets of the cloud infrastructure deployment.

19. The system of claim 16, wherein the operations further comprise determining a first volumetric size of a first graphical element representing a first resource by making the first volumetric size proportional to a first value of a first parameter associated with the first resource.

20. A non-transitory computer readable storage medium storing instructions, which when executed by at least one data processor, result in operations comprising:
detecting a request to render, in a user interface on a computing device, a three-dimensional landscape view of a plurality of resources deployed for a given entity in at least one cloud platform;
retrieving, from one or more database tables, at least one parameter associated with each resource of the plurality of resources deployed for the given entity in the at least one cloud platform;
for each parameter, determining a volumetric size based on a value of the parameter;
rendering volumetric graphical elements with the determined volumetric sizes for the plurality of resources deployed for the given entity in the cloud platform; and
causing the rendered volumetric graphical elements to be displayed in the user interface as virtual buildings in a virtual city landscape, wherein the virtual buildings represent the plurality of resources deployed in the at least one cloud platform.
